(19) United States
(12) Patent Application Publication
(10) Pub. No.: US 2016/0147011 A1
(43) Pub. Date: May 26, 2016

(54) POLARISATION MAINTAINING OPTICAL FIBER PACKAGE

(71) Applicant: FIBERCORE LIMITED, Chilworth, Southampton Hampshire (GB)

(72) Inventors: Judith HANKEY, Chilworth, Southampton, Hampshire (GB); Christopher EMSLIE, Chilworth, Southampton, Hampshire (GB)

(21) Appl. No.: 14/901,182

(22) PCT Filed: Jul. 10, 2014
(86) PCT No.: PCT/GB2014/052118

§ 371 Date: Dec. 28, 2015

(30) Foreign Application Priority Data
Jul. 11, 2013 (GB) 1312435.9

(51) Int. Cl. G02B 6/024; G02B 6/036

(52) U.S. Cl. CPC G02B 6/024; G02B 6/03694

(57) ABSTRACT

A polarisation maintaining optical fiber package is described. The fiber comprises a core having a core diameter, a first protective coating layer surrounding the core, the first protective coating layer having a first protective coating inner diameter, a first protective coating outer diameter and a first protective coating thickness between the first protective coating inner diameter and the first protective coating outer diameter, a second protective coating layer surrounding the first protective coating layer, the second protective coating layer having a second protective coating inner diameter and a second protective coating outer diameter, the first protective coating layer comprising a material having a first hardness and the second protective coating layer comprising a material having a second hardness, wherein the thickness of the first protective coating layer is in the range from 6% to 33% of the core diameter. The thickness of the coatings in the package is such that the optical fiber core exhibits a reduction in strain and stress sensitivity over a wide range of temperatures, even down to around minus 20 degrees C.

The present invention relates to an improved optical fiber, in particular to an optical fiber with a cladding protective coating structure providing improved stress isolation. The invention relates to a method of producing a fiber having improved stress isolation.

The performance of optical fiber and in particular polarisation maintaining (PM) optical fiber is affected by external factors such as stress. Applied stress influences, amongst other things, the guidance and polarisation characteristics of the optical fiber. This is noticeable particularly at low temperatures, below around minus 20° C. Stresses and forces exerted within the (glass) fiber structure cause a change in the refractive index of the glass and thereby influence both the modal and polarisation behaviour of the fiber.

In recent years there has been growth in the use and deployment of sensors for monitoring of, for example, oil and gas installations and equipment. In addition, a greater number of Fiber Optic Gryroscope (FOG) packages are now supplanting existing Ring Laser Gyroscope (RLG) technologies in applications. The industry and customer demand for ever higher accuracy and precision is placing increasing emphasis on the fundamental performance of the polarisation maintaining (PM) fiber used in FOG sensor coils. Increased precision is currently achieved by increasing the optical path length within the sensor because this increases the phase-shift generated by rotation (known as the Sagnac Effect). However, the attendant increase in fiber length subjects the FOG to increased micro-bending and stress, due to the greater number of over-winds within the coil package of the FOG. The stress and winding inevitably reduces the polarisation-maintaining performance of the fiber, as externally applied stress negates the intrinsic stress by which any ‘stress birefringent’ fiber functions. Fiber performance is challenged even further when other market trends, for example the demand for smaller, more compact sensors and also the need to operate at temperatures below around −40° C. are also considered.

In accordance with a first aspect of the present invention, there is provided a polarisation maintaining optical fiber package comprising:
a core having a core diameter,
a first protective coating layer surrounding the core, the first protective coating layer having a first protective coating inner diameter, a first protective coating outer diameter and a first protective coating thickness between the first protective coating inner diameter and the first protective coating outer diameter,
a second protective coating layer surrounding the first protective coating layer, the second protective coating layer having a second protective coating inner diameter and a second protective coating outer diameter,
the first protective coating layer comprising a material having a first hardness and the second protective coating layer comprising a material having a second hardness,
wherein the thickness of the first protective coating layer is in the range from 6% to 33% of the core diameter and whereby the optical fiber core exhibits a reduction in strain and stress sensitivity.

The conventional approach to reducing stress sensitivity in an optical fiber is to use a combination of coatings for the fiber. A dual-layer coating package comprising a primary and a secondary coating around an optical fiber comprising a glass core (optical guiding core) and in some cases glass cladding is a design largely based on fiber production and design techniques from the telecommunications industry. In this case a relatively thick, primary coating layer of a soft polymer surrounded by a secondary layer of harder material is considered appropriate and the conventional approach until now has been that the soft primary layer must be of a sufficient thickness to absorb any external penetration and thereby reduce or prevent the transfer of stress to the optical fiber and the optical core itself. In fact with the first aspect of the present invention a much thinner primary layer than has, until now, been customarily used is advocated and it provides significantly increased resistance to applied stress, such as external forces, impingements in or against the fiber package and bending.

In the present invention, the optical fiber package comprises an optical fiber and may comprise one or more coatings surrounding the fiber. The fiber as described has an elongate cylindrical shape, comprising a central optical core of, for example, 3-8 microns in core diameter. Additional optical material such as optical cladding layers may form part of the fiber and surround the optical core. A first protective coating layer surrounding the fiber is of elongate shape and has a thickness equal to the difference between the outer diameter and the inner diameter of the first protective coating layer. In a similar manner a second protective coating layer, comprises a hollow, cylindrical tube and has an inner diameter substantially the same as the outer diameter of the first protective coating layer and a larger outer diameter. The outer diameter of the second protective coating layer layer marks the extent of the optical fiber package. The thickness of the protective coating layers is the development claimed.

The features of the invention are as set out below and as in the accompanying claims.

In an embodiment the core comprises an optical core and one or more cladding layers as set out above and in an embodiment the first hardness is less than the second hardness such that the first protective coating layer comprises softer material than the second protective coating layer. Improved understanding of the fiber package structure and the benefits of a softer first protective coating first protective coating later were arrived at with finite element modelling and were supported by test results. The modelling took account of the forces associated with stress induced by a fiber impinging directly adjacent the fiber package (as might occur in use or in transit) and a bending scenario.

In an embodiment the optical fiber package comprises a silicon glass core. In a preferred embodiment the core has a diameter in the range from 50 to 130 microns, in a particular embodiment the core diameter is around 80 microns. This range of sizes is particularly suitable for fiber sensors and sensing applications.

In the telecommunications fiber industry a thinner first or primary protective coating has not, so far, been a popular choice of packaging design. The reluctance of the industry to use a thinner coating is likely due to inferior handling properties and an increased tendancy for a corresponding thicker, harder secondary protective coating to fracture. It has been thought that a thicker, softer primary layer of protective coating was important in order to absorb external penetrations and incursions and prevent or at least reduce the transfer of stress to the optical fiber and the optical core itself. In a counter intuitive development the present invention makes use of the different coating thicknesses to address the needs of high precision of fiber packages for FOG and sensors across a broad temperature range.

In an embodiment the thickness of the first protective coating layer around the core is in the range from 12 to 60 microns. The range has been found to be most useful for the relatively thin first, or primary protective coating. A further preferred embodiment comprises an optical fiber package comprises a second protective coating thickness between the second protective coating inner diameter and the second protective coating outer diameter, wherein the thickness of the second protective coating layer around the first protective coating layer is in the range from 10 to 60 microns. This second layer of coating has been found sufficient protection for guarding against stress in the core of the fiber.

The tests and calculations carried out on the fiber package indicate that the thinner than customary primary or first protective layer provides significantly increased resistance to applied stress, therefore leading to improved fiber and package performance. The reduced coating diameter provides an improved isolation of the glass fiber from external stress as the increased outer (secondary) coating functions and acts as a hard ‘shell’ to dissipate stress more effectively than a thin outer layer would do. Thus, less stress arrives at the primary, first protective layer, close to the fiber. Transfer of thermal stress is also minimised through the reduction in the volume of the primary protective coating material required. This leads to less manufacturing cost. In addition the softer materials have higher coefficeient of expansion than the harder material now located as the secondary layer.

The first protective coating outer diameter in an embodiment is in the range from 90 to 130 microns and the second protective coating outer diameter is in the range of 135 to 175 microns in an embodiment. Overall the package requires less material so this leads to reduced manufacturing costs, due to less coating material and less time for coating required.

In calculations and testing the most improved results are with 80 μm glass diameter fiber, coating thickness of around 95 μm.

The optical fiber package of a preferred embodiment has a first protective coating layer comprising material having an elastic modulus in the range from 0.5 to 500 MPa and can be up to 2000 MPa. In an embodiment the optical fiber package described here provides a reduction in stress is 40 to 60% of that of a standard optical fiber package. This provides improvements in overall performance and reduces the effects of externally applied stress and micro bending upon the fiber itself. This improvement is particularly suitable for fibers and devices that function via a stress mechanism, such as PM fibers mentioned above. It enables high polarisation extinction ratios to be maintained at lower temperatures and across a broad range.

The embodiment provides an optical fiber package where the operational temperature range is across the range from 105 to −60° (degrees) C.

In an embodiment the optical fiber package has a coating comprising any one of the group; radiation-cured coating materials including but restricted to epoxy-acrylates, urethane-acrylates, silicone rubbers (including rtv silicones), polyimides and epoxies. These materials are particularly suitable for packaging and operation across the required temperature range. Suitable materials are available to purchase from ShinEtsu.

The optical fiber of the preferred embodiment is such that the fiber is incorporated into one of the group comprising; a fiber sensor, a strain gauge, a cable formation, a wound cable formation, a phase modulation apparatus; a Fiber Optic Gyroscope. The present fiber package is particularly suitable for these devices and fiber uses.

In accordance with the present invention as seen from a further aspect, there is provided a method of fabricating an optical fiber package as described and set out above in accordance with the present invention. Manufacturing techniques for fibers having coating arrangements are well known and include fabrication from a preform module and extrusion with a fiber drawing tower. The fiber as described above may be manufactured by any suitable fabrication technique.

Embodiments of the present invention will now be described by way of example only and with reference to the accompanying drawings, in which:

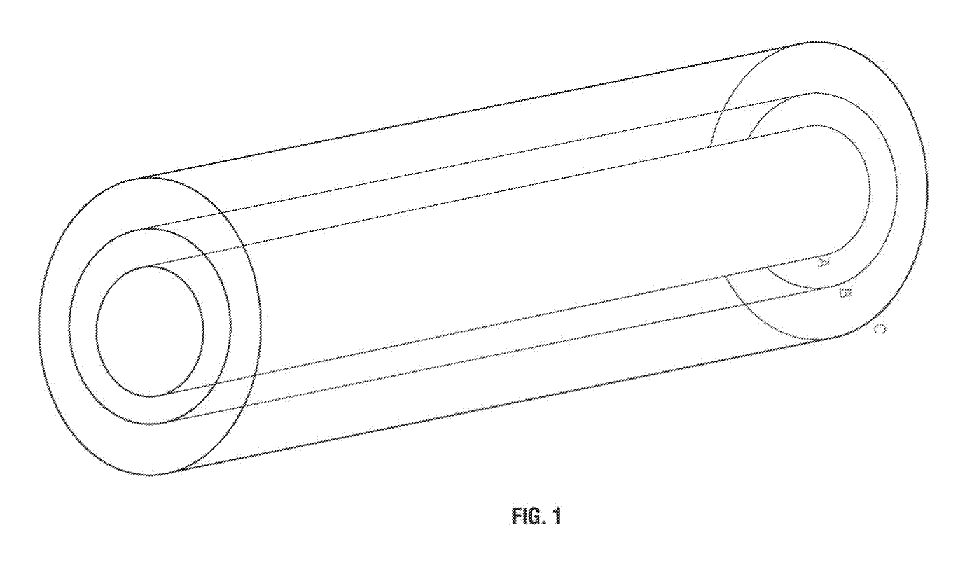

FIG. 1 is a schematic view of the fiber and protective coating arrangement of the present invention; and

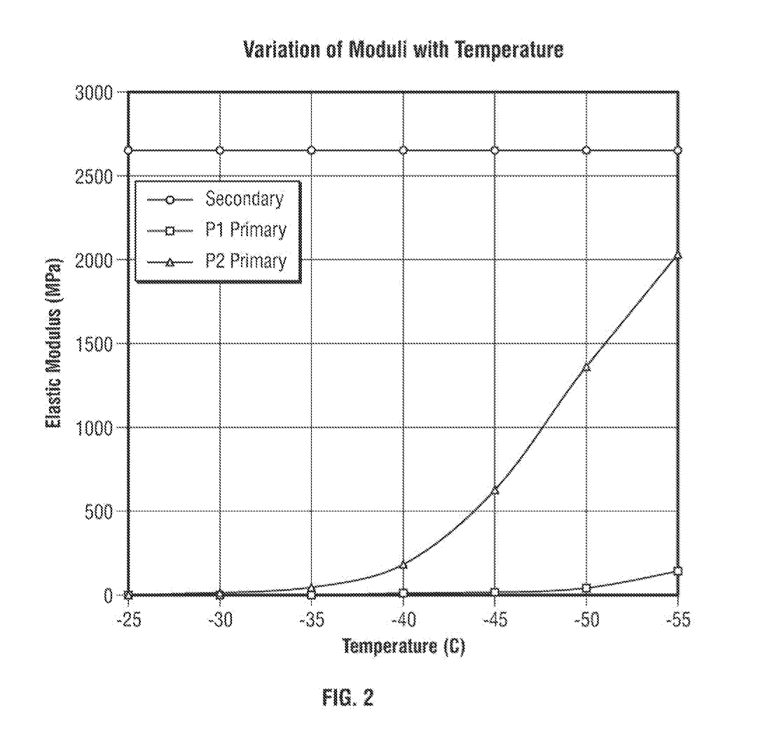

FIG. 2 is a graphical representation of the stress sensitivity and response of the fiber and protective coating package across a temperature range.

The fiber shown in FIG. 1 comprises an optical core, comprising glass material and having diameter A, a first protective outer coating of thickness B and a secondary protective coating of thickness C. A is around 80 μm, B is thinner than customary and of softer material than the outer coating, as described above.

In particular the first protective coating layer comprises a material having a first hardness and the second protective coating layer comprising a material having a second hardness, wherein the thickness of the first protective coating layer is in the range from 6% to 33% of the core fiber diameter and whereby the optical fiber core exhibits a reduction in strain and stress sensitivity.

In FIG. 2 the results show that stress levels within PM fibers may be reduced by up to 50% within the most challenging temperature range of −20 to −55° C. through optimisation of the protective coating package and that a corresponding improvement may be measured in the practical, polarisation maintaining ability of the fiber.

Examples of the use of the protective coating package and arrangement described above are in polarisation maintaining fibers in, for example, interferometric sensors, also a fiber sensor in a cable arrangement, or a phase modulation apparatus. By invention fibers would also be protected from microbending induced loses such as from cabling processes. This may apply with, for example, an inherently flexible fiber of less than 125 μm in glass diameter. The invention of reduced primary thickness also has capacity to improve fiber response under strain based modulation, thus setting out the possibility of improved sensor performance.

Various modifications may be made to the described embodiments without departing from the scope of the present invention. The fiber package may be of a different size to that described, for example fibers of 125 μm may be used. There may be a different number of coatings or stages. The material may comprise other optical quality compositions, and may include a variety of dopants for particular use or detection or chosen for their operational characteristics. The values of the protective coating layers can change providing a thinner than customary primary, first, coating layer together with a corresponding increase in thickness of the secondary layer.

Other shapes or sizes may be used, and the guiding structure may be of any convenient section, e.g. round or rectangular. Other coating arrangements and scenarios may be envisaged.

1. Polarisation maintaining optical fiber package comprising a core having a core diameter, a first protective coating layer surrounding the core, the first protective coating layer having a first protective coating inner diameter, a first protective coating outer diameter and a first protective coating thickness between the first protective coating inner diameter and the first protective coating outer diameter, a second protective coating layer surrounding the first protective coating layer, the second protective coating layer having a second protective coating inner diameter and a second protective coating outer diameter, the first protective coating layer comprising a material having a first hardness and the second protective coating layer comprising a material having a second hardness, wherein the thickness of the first protective coating layer is in the range from 6% to 33% of the core diameter and whereby the optical fiber core exhibits a reduction in strain and stress sensitivity.

2. Optical fiber package according to claim 1, wherein the core comprises an optical core and one or more cladding layers.

3. Optical fiber package according to claim 1, wherein the first hardness is less than the second hardness such that the first protective coating layer comprises softer material than the second protective coating layer.

4. Optical fiber package according to claim 1, wherein the core comprises silica glass fiber.

5. Optical fiber package according to claim 1, wherein the core has a core diameter in the range from 50 to 130 microns.

6. Optical fiber package according to claim 5, wherein the core diameter is around 80 microns.

7. Optical fiber package according to claim 1, wherein the thickness of the first protective coating layer around the core is in the range from 12 to 60 microns.

8. Optical fiber package according to claim 1, further comprising a second protective coating thickness between the second protective coating inner diameter and the second protective coating outer diameter, wherein the thickness of the second protective coating layer around the first protective coating layer is in the range from 10 to 60 microns.

9. Optical fiber package according to claim 1, wherein the first protective coating outer diameter is in the range from 90 to 130 microns.

10. Optical fiber package according to claim 1, wherein the second protective coating outer diameter is in the range of 135 to 175 microns.

11. Optical fiber package according to claim 1, wherein the first protective coating layer comprises material having an elastic modulus in the range from 0.5 to 500 MPa.

12. Optical fiber package according to claim 1 wherein the reduction in stress is 40 to 60% of that of a standard optical fiber package.

13. Optical fiber package according to claim 1 wherein the operational temperature range is across the range from 105 to −60 degrees C.

14. Optical fiber package according to claim 1, wherein the protective coating material comprises any one of the group; radiation-cured coating materials including but restricted to epoxy-acrylates, urethane-acrylates, silicone rubbers (including rtv silicones), polyimides and epoxies.

15. Optical fiber package according to claim 1, wherein the optical fiber is incorporated into one of the group comprising; a fiber sensor, a strain gauge, a cable formation, a wound cable formation, a phase modulation apparatus; a Fiber Optic Gyroscope.

16. (canceled)

17. (canceled)
